(19) United States
(12) Patent Application Publication
(10) Pub. No.: US 2015/0270731 A1
(43) Pub. Date: Sep. 24, 2015

(54) TOPOLOGY AND CONTROL STRATEGY FOR HYBRID STORAGE SYSTEMS

(71) Applicants: Peter Adelmann, Illerkirchberg (DE); Oliver Wolst, Singapore (SG); Mao Jun He, Singapore (SG); Mahmoud Hamada, Stuttgart (DE); Falco Sengebusch, Singapore (SG); Yanlin Li, Changning (CN); Annika Kufner, Munchen (DE)

(72) Inventors: Peter Adelmann, Illerkirchberg (DE); Oliver Wolst, Singapore (SG); Mao Jun He, Singapore (SG); Mahmoud Hamada, Stuttgart (DE); Falco Sengebusch, Singapore (SG); Yanlin Li, Changning (CN); Annika Kufner, Munchen (DE)

(73) Assignee: Robert Bosch (SEA)PET. LTD., Singapore (SG)

(21) Appl. No.: 14/424,167

(22) PCT Filed: Sep. 3, 2012
(86) PCT No.: PCT/IB2012/054534

§ 371 Date: Jun. 2, 2015

(51) Int. Cl. H02J 7/00; H02J 7/35

(52) U.S. Cl. CPC H02J 7/0052; H02J 7/35

(57) ABSTRACT

A hybrid battery charging device includes: input terminals for connecting a photovoltaic panel or other current sources; first battery connections for connecting a lead-acid battery; second battery for connecting a high-cycle chemical battery; a two-way DC/DC converter having a first set of terminals connected with the second battery connections, and a second set of terminals connected with the first battery connections, an input of the second set of terminals being derived from the input terminals; a charge-and-discharge control system which is connected to the DC/DC converter via respective control lines; and output terminals for connecting a load, an input to the output terminals being derived from the first battery connections.

### BACKGROUND OF THE INVENTION

1. Field of the Invention

The present invention relates to a hybrid storage system for a re-mote energy system (RES).

2. Description of the Related Art

Lead acid batteries have been used for years as the main storage medium in off-grid solar systems and in remote energy systems (RES) in general. The popularity of lead acid batteries is mainly motivated by their low purchasing price. However, over the total lifetime of a RES, the Pb battery often becomes the main cost driver since it has to be changed every 1 to 3 years resulting in high costs for acquiring and changing several batteries. This relatively short lifetime, compared, for example, to lead (Pb) batteries in back-up systems, is due to the nature of remote energy applications. For example, in an off-grid solar system a battery is partly charged during daytime for several hours depending on the geographic location and on the weather and mainly discharged during night time, for example for running light bulbs, for running a TV set or other equipment and machinery. Due to these conditions, the Pb battery remains most of the time in a low state of charge (SOC) and it is rarely fully charged. These aspects affect the capacity of a lead-acid battery since they tend to increase the sulfation process in a lead acid battery.

U.S. Pat. No. 6,353,304 discloses providing two battery strings, which can be connected to an AC power source via AC/DC converters and switches, such that one battery string is loaded while the other battery string is discharged. This arrangement can pro-vide an improved battery management for solar hybrid systems that have a generator besides the solar cells. By contrast, the present application provides an improved charging and discharging even when there is only a photovoltaic energy source available.

It is an objective of the present application to provide an improved hybrid storage system and improved methods for charging and discharging batteries of the hybrid storage system.

The present application provides a hybrid battery charging device with input terminals for connecting a photovoltaic panel and first battery connections for connecting a lead-acid battery. A lead acid battery according to the application comprises various types such as a liquid acid battery, a lead-gel battery or an absorbent glass mat (AGM) lead battery.

Furthermore, the battery charging device comprises second battery connections for connecting a high cycle chemical battery. Preferentially, a lithium battery such as a lithium-ion battery or a lithium polymer battery provides the high cycle chemical battery but other high cycle chemical batteries such as a Nickel-Iron battery may also be used.

Within the context of the present application a “chemical battery” refers to a battery in which a charging or discharging of the battery involves the movement of ions and chemical reactions at the respective anodes of the battery. This stands in contrast to capacitors such as plate capacitors, electrolytic capacitors or double layer capacitors, which are also known as supercapacitors, wherein charging or discharging merely involves the rearrangement of electrons or of other charged particles without a chemical reaction taking place. Furthermore, a high-cycle chemical battery according to the application is a rechargeable battery.

According to the application, the characteristics of a high-cycle chemical battery complement the characteristics of the lead-acid battery. The lead-acid battery is well adapted to being fully charged or even slightly overcharged while the high-cycle chemical battery is well adapted to a deeper discharge level. Lead acid-batteries are relatively inexpensive and are often used for remote energy systems. Such a lead-acid battery can even be provided by a simple car battery but it is more advantageous to use specially adapted batteries which tolerate deeper discharges.

The battery charging device comprises a two-way DC/DC converter, which is also known as bidirectional DC/DC converter. The two-way DC/DC converter is used to charge the lithium battery in a first current direction as well as to discharge the lithium battery in a second current direction.

A first set of terminals of the two-way DC/DC converter is connected with the second battery connections and a second set of terminals of the two-way DC/DC converter is connected with the first battery connections. An input to the second set of terminals is derived from the input terminals of the hybrid battery charging device. Herein, an input of B being “derived” from A means that B receives an input from A, wherein the input may be transmitted from A to B directly via an electric line or indirectly via other components such as switches, transistors etc.

Furthermore, a charge and discharge control system is provided, which is connected to the two-way DC/DC converter via respective control lines and output terminals for connecting a load. An input of the output terminals is derived from the first battery connections via a connecting means for connecting the output terminals to the first battery connections, such as a magnetic switch or a semiconductor switch.

In the direct current circuits of the hybrid battery charging device, either one of the poles may be connected to a common ground in a known way. For example, a minus pole connection of the first battery connections and a minus pole terminal of the output terminals may be connected to a common ground potential. In other words, one of the respective battery connections and one of the output terminals may be provided by respective connections to the common ground potential. The input terminals of the two-way DC/DC converter are also referred to as “system terminals” and the voltage across the system terminals is also referred to as “system voltage”.

Furthermore, the hybrid battery charging device may comprise a control device such as a controlled on/off switch, a pulse width modulation (PWM), a maximum power point tracker, etc. for better controlling the charge voltage of the batteries. The control device is connected between the input terminal of the system and input terminals of the DC/DC converter, which are in turn connected to terminals of the lead-acid battery. Furthermore, the control device is connected to the charge and discharge control system via control lines. For example, the control lines may be configured for switching transistors of a PWM in the control device.

The two-way DC/DC converter may comprise, for example, a buck-boost converter, a buck converter or a boost converter for providing a suitable voltage ratio for charging or discharging the lithium battery. Especially, the two-way DC/DC converter may comprise a step-up converter for providing a higher voltage to the lithium battery than the end-of-charge voltage of the lead-acid battery.

In particular, the two-way DC/DC converter may comprise at least two semiconductor switches, wherein respective input connections of the transistors are connected to the charge control system via respective control lines. In this way, the two-way DC/DC converter is easy to control via electric signals. In particular, the transistors may be realized as power transistors.

Furthermore, the hybrid battery charging device may comprise first and second voltage measuring connections for connecting first and second voltage sensors. The first voltage sensor is connected to terminals of the lead-acid battery and the first voltage measuring connections are connected to the charge and discharge control system. The second voltage sensor is connected to terminals of the lithium battery and the second voltage measuring connections are connected to the charge and discharge control system, wherein the connection may be direct or also indirect via a separate controller for managing the state of charge of the lithium battery such as a voltage monitoring chip. The voltage monitoring chip may be connected to the voltage sensor of the lithium battery and to the charge control system via a control line.

In particular, the lithium battery, the two-way DC/DC converter and the voltage monitoring chip for the lithium battery may be mounted together in an energy storage subsystem, wherein the energy storage subsystem provides input terminals for plugging the energy storage subsystem into the hybrid battery charging device. Thereby, the building block comprising the lithium battery can be used and serviced separately from the rest of the hybrid battery charging device.

The first and second voltage sensors may be provided as component of the hybrid battery charging device, for example within the charge and discharge control system or they may be provided as components of the respective batteries.

The hybrid battery charging device may furthermore comprise a separate battery management system for the lithium battery, the separate battery management system that is connected to the charge and discharge control system. In this way, an existing battery charging device, for example a battery charging device for a lithium battery, or parts of it may be used in the hybrid battery charging device according to the application.

The application furthermore discloses a hybrid storage system with a hybrid charging device according to the application that further comprises lithium battery which is connected to the second battery connections.

Furthermore, the hybrid storage system may further comprise a capacitor such as an ultracapacitor, which is connected in parallel to the lithium battery, for a fast response to high load peaks of a connected load.

Furthermore, the application discloses a hybrid storage system with a hybrid charging device according to the application that further comprises a lead-acid battery that is connected to the first battery connections.

The hybrid storage system may comprise furthermore a first voltage sensor, which is connected to a terminal or to terminals of the first battery and to the charge and discharge control system, and a second voltage sensor, which is connected to a terminal or to terminals of the second voltage battery and to the charge and discharge control system.

Furthermore, the application discloses a method for charging a lead acid battery and a lithium battery of a hybrid storage system by an electric power source such as a photovoltaic panel.

According to the application, a lead-acid battery is charged in a first battery charging phase until the lead-acid battery has reached a first pre-determined state of charge. During the first battery charging phase, in which the lead-acid battery is charged, the charging may be controlled just by limiting to a maximum current or to perform unlimited charging or bulk charging, for example by a PID controller which uses the charging voltage and current as input data.

In an equalization phase, which is also known as a topping or boost phase, the lead-acid battery and the lithium battery are both charged until the lead-acid battery has reached a second pre-determined state of charge. In addition, the lead-acid battery and the lithium battery may also be charged during an “absorption phase” or a boost phase of the lead-acid battery. In the equalization and absorption phases, the system voltage is kept constant at different setpoints, which correspond to the phases.

During the equalization phase, an applied voltage at the lead-acid battery can be made to oscillate between a pre-determined lower voltage and a pre-determined upper voltage. In particular, the voltage may be applied by pulse charging, and especially by pulse-width modulated charging. The voltage of the charge pulses may be higher than the end of charge voltage of the lead-acid battery. The charge pulse can contribute to a higher charge and life expectancy of the lead-acid battery by equalizing the charges on the battery cells, mixing the electrolyte and reducing the sulfation. Furthermore, a mean voltage at terminals of the lead-acid battery is close to an end-of-charge voltage of the lead-acid battery during the equalization phase. During the equalization phase, the charge current to the lead-acid battery will decrease because the charge state of the lead-acid battery approaches 100%.

The lithium battery is charged in a third battery charging phase during which an essentially constant system voltage is applied to system terminals of the lead-acid battery and the first voltage is converted into a charging voltage at terminals of the lithium battery.

Advantageously, the essentially constant system voltage that is applied to the system terminals during the charging of the lithium battery in the third battery charging phase is made equal to a maximum open circuit voltage of the lead-acid battery. Thereby, the lead-acid battery will not discharge significantly, even if it remains connected to the lithium battery. On the other hand, an overcharging of the lead-acid battery is avoided by keeping the terminals of the lead-acid battery at its maximum open circuit voltage. In addition, a trickle or standby charge may be applied to the lead-acid battery during which the applied voltage may be higher than the maximum open circuit voltage of the lead-acid battery.

Furthermore, the application discloses a method for discharging a lead-acid battery and a lithium battery of a hybrid storage system. According to the application, a load is supplied with power by discharging the lithium battery via system terminals of the lead acid battery and maintaining the voltage at the system terminals essentially equal to a maximum open circuit voltage of the lead-acid battery until a voltage at terminals of the lithium battery has reached an end-of-discharge voltage of the lithium battery.

Thereby, it is not required to provide a direct connection between the lithium battery and the load. This ensures that the lead-acid battery is not already discharged, even if it is not disconnected. A controlled DC/DC converter can provide the required voltage, for example.

If the output voltage of the lithium battery has reached an end-of-discharge voltage of the lithium battery, the lead-acid battery is discharged until the voltage of the lead-acid battery has reached an end-of-discharge voltage of the lead-acid battery. The end-of-discharge voltage of the lead-acid battery is a voltage to which the lead-acid battery can be discharged safely. The end-of-discharge voltage of the lead-acid battery corresponds to a SOC of about 30-40% of the lead-acid battery.

Similarly, if a load draws current from the lithium battery such that a voltage at terminal of the lead-acid battery drops below a maximum open circuit voltage of the lead-acid battery, the lead-acid battery is discharged in parallel with the lithium battery until the lithium battery has reached an end-of-discharge voltage.

In addition, the lead-acid battery may be disconnected after discharging the lead-acid battery and/or the hybrid storage system may enter a standby mode until it is determined that an electric power source can supply enough power to load the first battery. The disconnection of the lead-acid battery may be achieved by an on/off switch for disconnecting the load and/or by a separate on/off switch, which is provided at the lead-acid battery. In particular, the standby mode may provide a reduced power consumption by suspending measurements of a system voltage at terminals of the first battery and of a voltage a terminals of the second battery.

Furthermore, the application discloses a hybrid battery charging device according to the application wherein the charge and discharge control system is operative for executing a charge or a discharge method according to the application. This may be realized for example by providing a computer readable program of a programmable microcontroller or a special purpose circuit, which is provided in the charge and discharge control device of the hybrid battery charging device.

In general, a hybrid storage system according to the application may be used wherever there is a need for an efficient intermediate storage of energy from an energy source. This applies in particular to energy systems in which a supply from an energy source and/or an energy demand of an energy consumer varies over time. More specifically, these conditions apply for off-grid applications, which are supplied by a varying energy source such as solar energy or wind energy.

An off-grid solar power station with a hybrid storage system according to the application may be used, for example, in remote geographical locations such as the interior of Africa or Brazil. Furthermore, it can also be used for powering installations that are typically located outside of agglomerations such as communication antennas, weather stations, fire observation towers, emergency shelters, devices in outer space etc.

### BRIEF DESCRIPTION OF THE DRAWINGS

FIG. 1 shows a general layout of a hybrid storage system according to the application.

FIG. 2 shows a more detailed view of the layout of FIG. 1.

FIG. 3 shows a circuit diagram of the hybrid storage system according to FIGS. 1 and 2.

FIG. 4 shows state of charge curves for a 12 V lead-acid battery under different conditions.

FIG. 5 shows a system voltage, a state of charge of a lead-acid battery and a state of charge of a lithium battery of the hybrid storage system during typical charging and discharging processes.

FIG. 6 shows the quantities of FIG. 5 for a discharge process for a high load.

FIG. 7 shows a flow diagram of a charging and a discharging process according to the application.

FIG. 8 shows a hybrid storage system with a first hybrid battery charging device according to the application.

FIG. 9 shows a hybrid storage system with a second hybrid battery charging device according to the application.

### DETAILED DESCRIPTION OF THE INVENTION

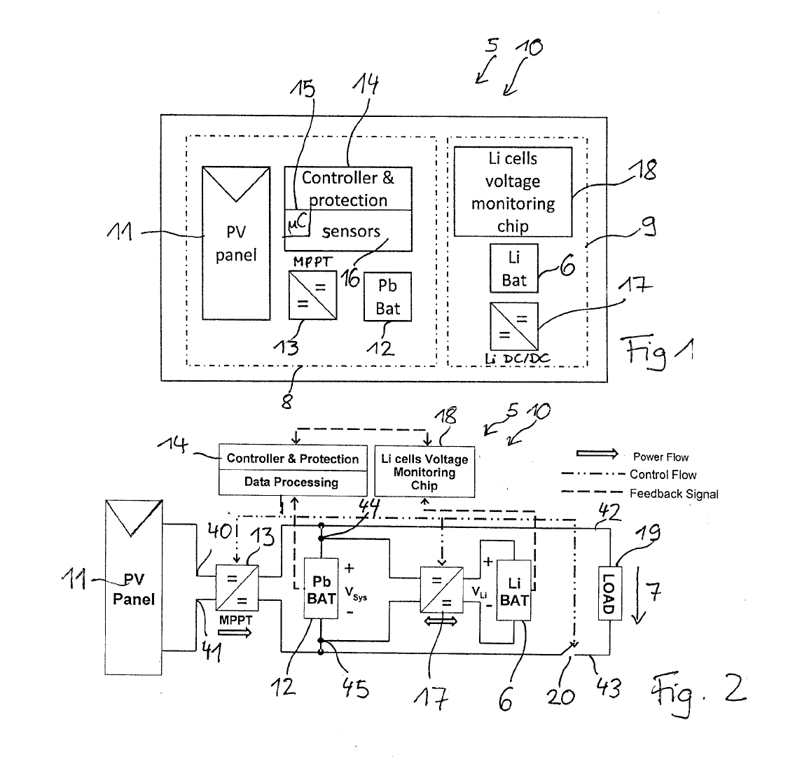

FIG. 1 shows a general layout of a hybrid storage system 5 with a hybrid battery charging device 10 according to the application. According to the application, a hybrid storage system comprises at least one battery while a hybrid charging device does not necessarily include the batteries.

The hybrid storage system 5 comprises a photovoltaic panel 11, a first energy storage subsystem 8 and a second energy storage subsystem 9. The first energy storage subsystem 8 comprises a lead battery 12, a unidirectional DC/DC converter 13 and a charge control system 14. The charge control system 14 comprises a microcontroller 15 and sensors 16. The sensors 16 comprise a voltage sensor at the terminals of the lead-acid battery. The DC/DC converter 13 is connected to a maximum power point tracker (MPPT). The maximum power point tracker provides an impedance matching for the photovoltaic panel 11 and it may be realized by a portion of the charge control system 14 and further hardware components.

Typically, the MPPT uses a measurement of the voltage across the photovoltaic panel 11, a measurement of the current from the photovoltaic panel 11 and, optionally, further measurements to generate a control signals corresponding to a reference voltage and/or to a reference current. MPPT algorithms comprise constant voltage, perturb and observe and incremental conductance algorithms.

Especially for remote energy systems with higher output powers (e.g. above 300 Watt) it is advantageous to use a maximum power point tracker (MPPT) in a system according to the application. Thereby, it is possible to achieve high efficiencies. However, a system according to the application can also be operated as with an off-grid solar system without an MPPT or input-DC/DC converter 13.

The second energy storage subsystem 9 comprises a lithium battery 6, a bidirectional DC/DC converter 17 and a voltage monitoring chip 18. The DC/DC converters 13 and 17 may be implemented in various ways, for example as buck converters, as boost converters or as buck-boost converters.

FIG. 2 shows a more detailed view of the layout of FIG. 1. According to the layout of FIG. 2, the lithium battery 6 is connected in parallel to the lead-acid battery 12 and to a load 19 via the bidirectional DC/DC converter 17. Furthermore, output lines of the DC/DC converter are connected in parallel to the lead-acid battery 12. A load switch 20 is connected in series to the load 19. The load switch 20 is provided to prevent a deep discharge and it may be implemented as a semiconductor switch such as a bipolar transistor, a FET, an IGBT, or others. An arrow 7 indicates a direction of current.

Dashed arrows in FIG. 2 indicate the flow of sensor signals to the charge control system 14 and to the voltage monitoring chip 18 while dash-double-dot arrows indicate the flow of signals between the charge control system 14 and the voltage monitoring chip and the flow of control signals from the charge control system 14.

The hybrid storage system provides a positive input terminal 40 and a negative input terminal 41, which are connected to corresponding output terminals of the photovoltaic panel (or other energy sources) 11, and a positive output terminal 42 and a negative output terminal 43, which are connected to corresponding input terminals of the load 19. The lithium subsystem 9 comprises a positive input terminal 44 and a negative input terminal 45, which are connected to respective terminals of the lead battery 12. Furthermore, the lithium subsystem 9 comprises a positive output terminal 46 and a negative output terminal 47 which are connected to respective terminals of the lithium battery 6.

For a load 19 that comprises an AC consumer, a DC/AC converter may be connected between the output terminals 42 and 43 and the load 19. A DC/AC converter may be provided, for example by a switched H-bridge or a switched three phase inverter.

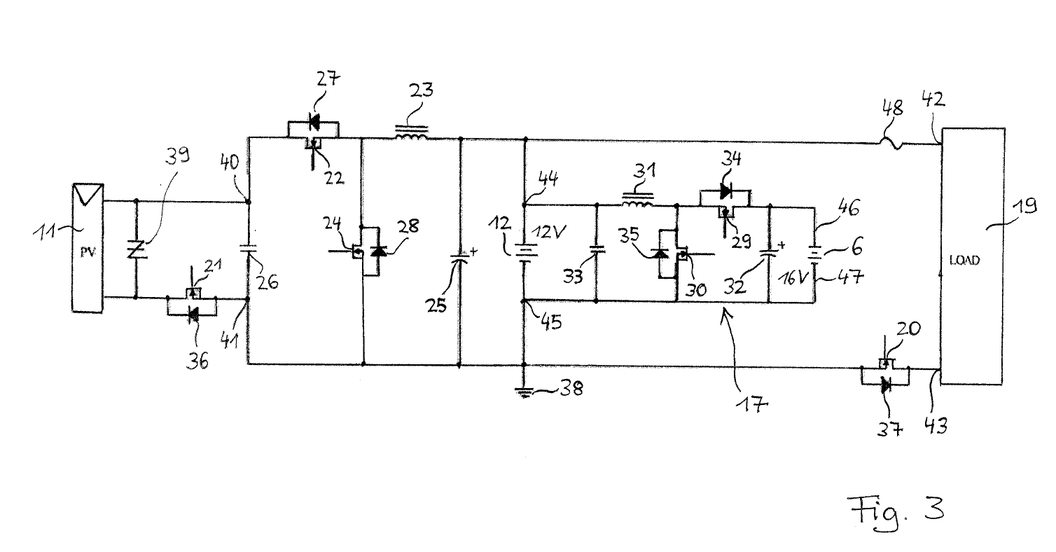

FIG. 3 shows a circuit diagram of the hybrid storage system 5 according to FIG. 2. In the example of FIG. 3, the lead-acid battery 12 can deliver a voltage of around 12 V and the lithium battery 6 can deliver a voltage of around 24 V. The photovoltaic panel 11 is connected to the hybrid storage system 5 via a reverse current protection MOSFET 21 (may also be a diode). A TVS-diode 39 for transient voltage suppression (TVS) and over-voltage suppression is connected in parallel to the photovoltaic panel 11.

The DC/DC converter 13, which is connected to outputs of the photovoltaic panel 11 and to battery terminals of the lead-acid battery 12, comprises a first MOSFET 22, a second MOSFET 24 and inductor 23, which are connected in star connection. A first terminal of a capacitor 25 is connected to a plus pole battery terminal of the lead-acid battery 12 and a second terminal of the capacitor 25 is connected to a minus pole battery terminal of the lead-acid battery 12.

Furthermore, a second capacitor 26 is connected in parallel to the input terminals 40 and 41 and works as an input filter. The first MOSFET 22 comprises a parasitic diode 27 and the second MOSFET comprises a parasitic diode 28.

During operation, the output power of the photovoltaic panel 11 or of the DC/DC converter 13 is measured by the charge control system 14. A control signal of the charge control system 14 adjusts the ratio of the DC/DC converter 13 via opening and closing of the MOSFETS 22 and 24 according to a maximum power point of the photovoltaic panel 11.

The DC/DC converter 17, which is connected to battery terminals of the lithium battery 6 and to battery terminals of the lead-acid battery 12, comprises a first MOSFET 29, a second MOSFET 30 and inductor 31 which are connected in star connection. A plus pole battery terminal of the lithium battery 6 is connected to a first terminal of a capacitor 32 and a minus pole battery terminal of the lithium battery 6 is connected to a second terminal of the capacitor 32.

The capacitors 25, 26, 32 and 33, on the other hand, act as filters for smoothing out the output voltage.

The first MOSFET 29 comprises a parasitic diode 34 and the second MOSFET 30 comprises a parasitic diode 35. The protection MOSFET 21 comprises a parasitic diode 36 and the load switch 20 comprises a parasitic diode 37. The parasitic diodes 27, 28, 34, 35, 36 and 37 also act as freewheel diodes with respect to the corresponding MOSFETS 22, 24, 29, 30, 21 and 20. Instead of MOSFETS, other field effect transistors may be used as well, like for example IGBTs, JFETs or others.

A fuse 38 is provided close to a positive output terminal of the hybrid storage system 5 to protect the circuitry of the hybrid storage system 5 from overload. A ground potential 38 is connected to the minus pole terminal of the lead-acid battery 12, to the minus pole terminal of the lithium battery 6 and to respective terminals of the capacitor 25, the second MOSFET 24 and the second capacitor 26 of the DC/DC converter 13.

According to the application, separate switches at the batteries 6, 12 are not required. The lead acid battery 12 and the lithium battery 6 may be equipped with switches, respectively, for connecting and disconnecting the lead acid battery 12 and the lithium battery 6, however.

The DC/DC converter 13 is controlled through control signals at the respective gate electrodes of the MOSFETS 24 and 22 and the DC/DC converter 17 is controlled through control signals at the respective gate electrodes of the MOSFETS 29 and 30. The DC/DC converters 13 and 17 can be operated as charge pulse generators by applying pulse width modulated pulses at the respective bases or gates of the respective transistors.

In a charge mode, the charge pulses can be used for charging the batteries lead-acid battery 12 and the lithium battery 6 and, in a recovery mode, they can be used for desulfurization of the lead acid battery 12. With respect to charging, the term “pulse-width modulation” (PWM) refers to applied signals at semiconductor switches. The generated charge or voltage pulses will in general not take the shape of rectangular pulses. This is different from the output of a switched H-bridge for driving a motor via PWM, for example.

During operation, a voltage of the lithium battery 6 is measured by the voltage monitoring chip 18 and a voltage of the lead-acid battery 12 is measured by the charge control system 14. The charge control system 14 adjusts the current of the DC/DC converter 13 via control signals to the MOSFETS 22 and 24. Similarly, the charge control system 14 adjusts the cur-rent or power through the DC/DC converter 17 via control signals to the MOSFETS 29 and 30. By increasing the input voltage through the DC/DC converters 13 and 17, the photovoltaic panel can be used for charging the batteries 12 and 6 even in periods of weaker insolation.

Furthermore, the charge control system 14 controls the opening and closing of the protection MOSFET 21 and of the load switch 20 by respective control signals.

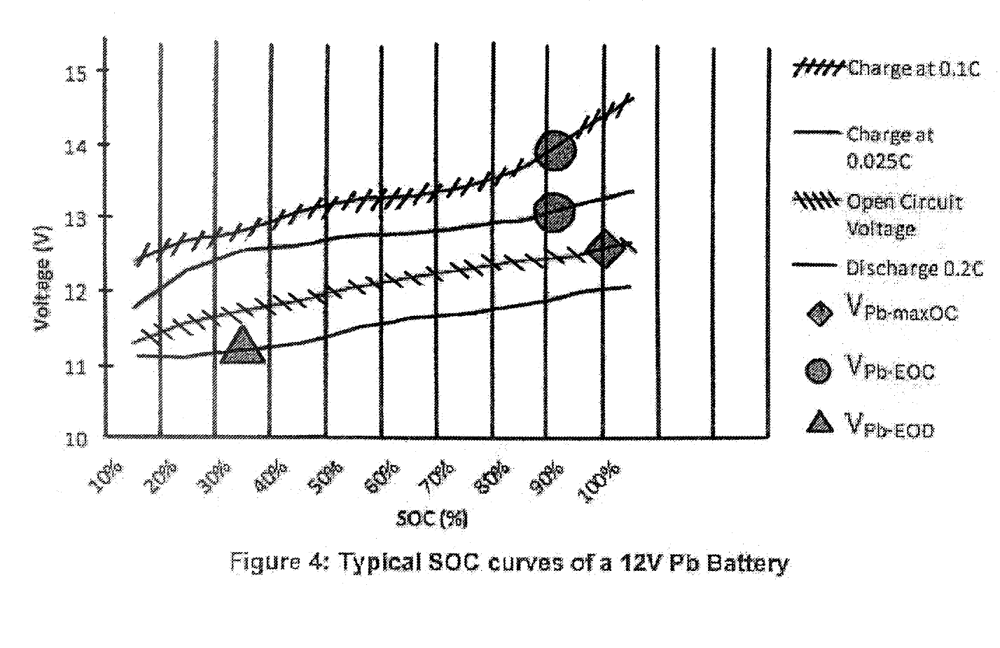

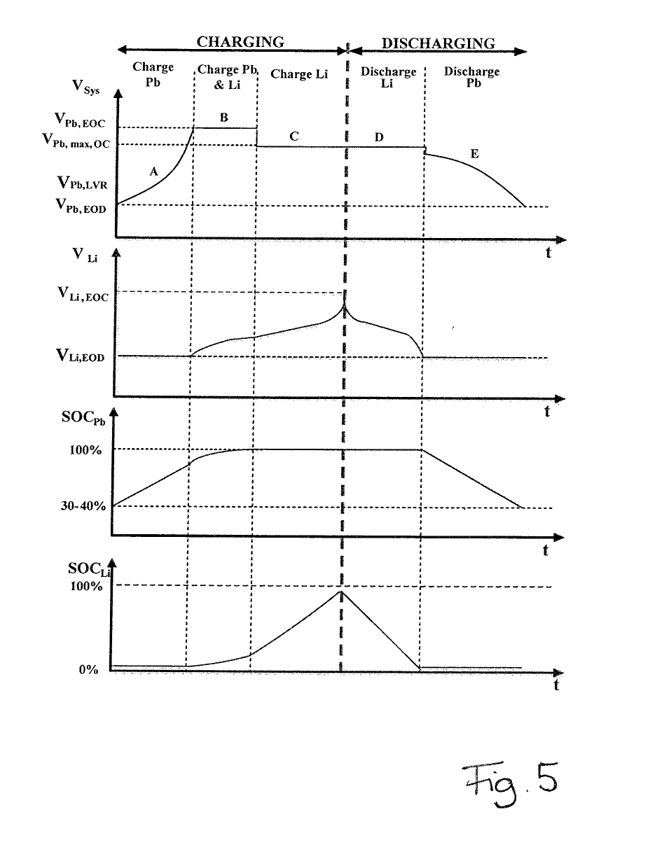

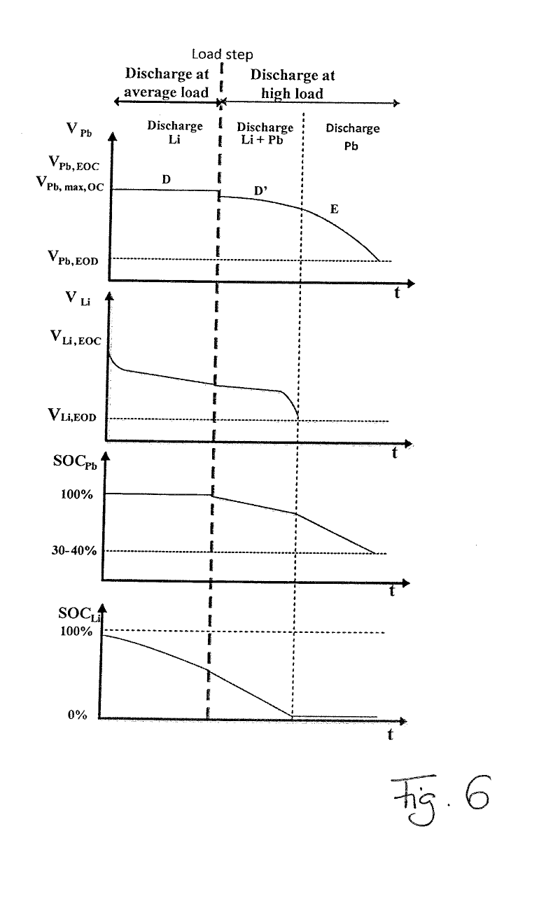

The generation of the control signals of the charge control system 12 according to the application is now explained in more detail with respect to the following FIGS. 4 and 5.

FIG. 4 shows state of charge curves for a 12 V lead-acid battery under different conditions. The topmost curve shows an external voltage that is required for charging the lead-acid battery at a charge rate of 0.1 C. This charge rate signifies a capacity of a battery in ten hours. At a charge rate of 0.1 C, the lead-acid battery reaches an end-of-charge volt-age V_EOC of about 13.5V at a state of charge (SOC) of about 90%, which is indicated by a circle symbol. The second curve from the top shows an external voltage that is required for charging the lead-acid battery at a charge rate of 0.025 C. In this case, the lead-acid battery reaches an end-of-charge voltage V_EOC of about 13V at a state of charge of about 90%, which is indicated by a circle symbol.

The second curve from below shows open circuit voltages for different charge states of the lead-acid battery. A maximum open circuit voltage V_maxOC of about 12.5 Volt is marked by a diamond symbol. The lowest curve shows a voltage that is delivered by the lead-acid battery when a load is chosen such that the lead-acid battery is discharged at a discharge rate of about 0.2 C. At a charge state of about 35% battery charge, an end of discharge voltage is reached. The voltage V_EOD between the battery terminals of the lead-acid battery at the end of discharge, which is at about 11.2 Volt, is marked by a triangle symbol.

In general, the following voltages are used in the control algorithms according to the application.
V_Sys, which corresponds to the voltage of the Pb battery 12 and to the voltage at the second set of terminals of the DC/DC converter 17. According to the application, a decision on which battery is charged or discharged depends on V_sys and, as an option, on the current.
V_EOC, which denotes an end-of-charge voltage. In lithium batteries, this voltage (V_Li_EOC) can correspond to a SOC of about 100%. By contrast, the end-of-charge voltage in lead (Pb) batteries (V_Pb_EOC) corresponds to a SOC of 85-90%. In order to reach an SOC of 100%, the lead battery has to be charged further after the end-of-charge voltage has been reached. As shown in FIG. 4, the voltage V_Pb_EOC can depend on the charge rate. Furthermore, it also depends on characteristics of the lead battery such as age and operating temperature.
V_EOD, which denotes an end-of-discharge voltage. In lithium batteries, this voltage (V_Li_EOD) corresponds to a certain low level of SOC, whereas in lead batteries, in order to avoid damage to the battery, this voltage (V_Pb_EOD) will correspond to a SOC of e.g. 30-35%, as shown in FIG. 4. The voltage V_Pb_EOD depends also on the discharge current, age of the battery and battery temperature. It does not correspond to a predetermined fixed value in the control storage algorithm.

In a charging method according to the application, a pulse width modulation (PWM) charging mode is used to charge the lead-acid battery 12. The PWM charging mode provides an efficient charging mode for lead-acid batteries. A surplus energy, which is not needed for the PWM charging of the lead-acid battery 12, is automatically transferred to the lithium battery 6 of the lithium subsystem 9. Thereby, a surplus of electric energy from the photovoltaic cells 11 is used to charge the lithium battery 6.

In a discharging method according to the application, the lithium subsystem is controlled to maintain a system voltage V_sys at a threshold voltage that corresponds to a voltage of the fully charged lead-acid battery 12. The system voltage V_sys is indicated in FIG. 2 by an arrow and it is measured between the connection lines to the lead-acid battery 12, which are connected to terminals of the lithium subsystem 9.

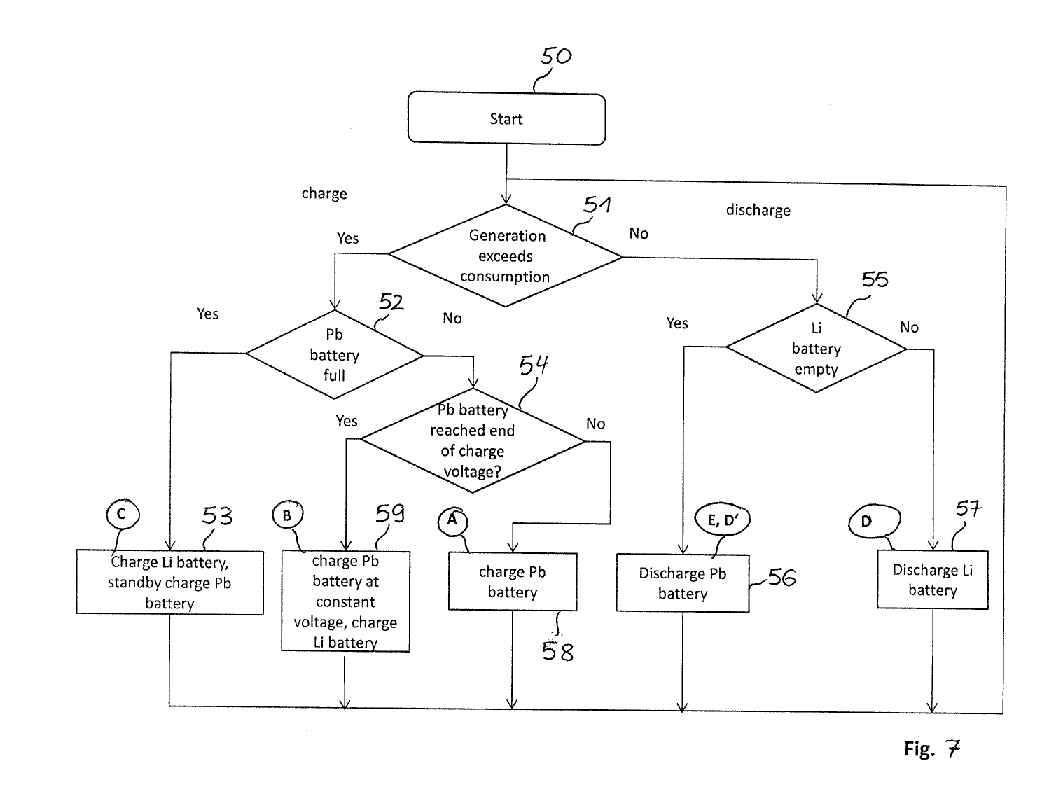

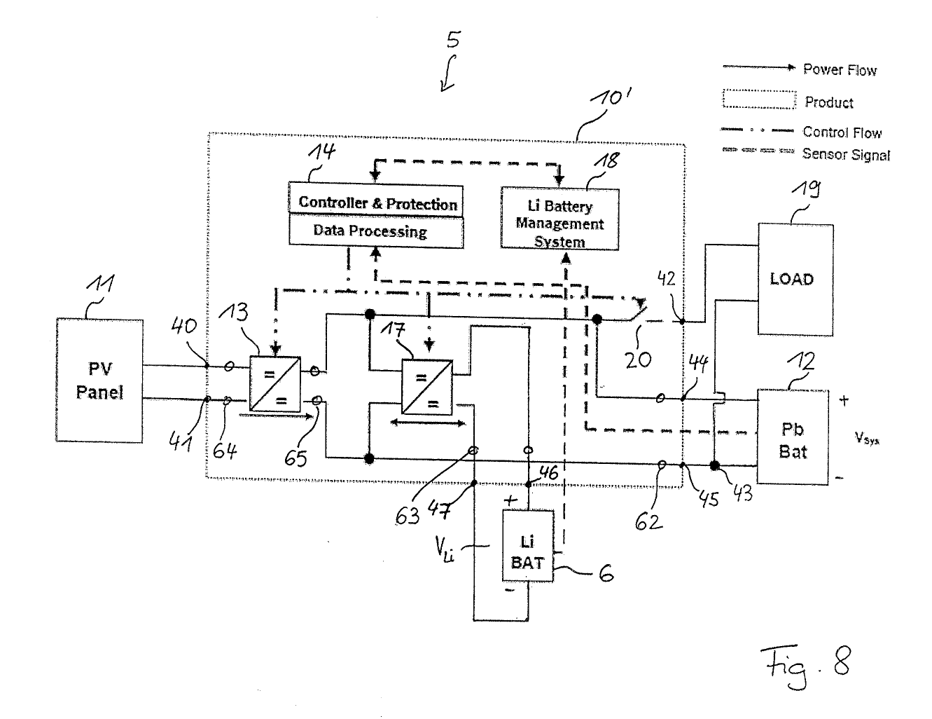

FIG. 5 shows voltage and state of charge diagrams for the lead-acid battery and for the lithium battery during a charging process according to the application. In FIGS. 5 and 6, system states, which are determined by the charge states of the two batteries is labelled by letters A to E. The letters correspond to labels in the flow diagram of FIG. 7. The letters A-E furthermore denote charge and discharge phases. As shown in FIG. 6, there is an additional discharge phase D-D′ when the load draws more power than the lithium battery 6 can deliver. In this case the lead-acid battery, which is also connected to the load, will discharge simultaneously as the system voltage falls below the end of charge voltage of the lead-acid battery 12.

During the charging and the discharging process the charge control system 14 estimates the states of charge SOC_Pb and SOC_Li of the batteries 6, 12 based on the time dependence of the system voltage and/or on the current supplied to the batteries 6, 12.

In a first charging phase A, only the lead-acid battery 12 is charged. In the example of FIG. 5, a voltage at the lead-acid battery 12 is at an end-of-discharge voltage V_Pb_EOD and a voltage at the lithium battery 6 is at an end-of-discharge voltage V_Li_EOD.

During the first charging phase, the state of charge of the lead-acid battery 12 increases. The system voltage V_sys at terminals of the lead-acid battery 12 is measured in regular time intervals. As soon as the system voltage V_sys reaches the end-of-charge voltage V_Pb_EOC of the lead-acid battery 12, a second charging phase starts. In the second charging phase B, the lead-acid battery and the lithium battery are both charged. As soon as the state of charge SOC_Pb of the lead-acid battery 12 reaches approximately 100%, a third charging phase C is started, in which the lithium battery 6 is charged with a current and the lead-acid battery 12 is kept at the same SOC with a trickle charge. This can be seen in the state of charge diagrams, which show an increase of the lithium battery's state of charge and a constant state of the charge for the lead-acid battery.

FIG. 5 also shows a discharging process according to the application for a situation in which both batteries 6, 12 are fully charged at the beginning of the discharging process. In a first discharging phase D, only the lithium battery 6 is discharged. In the example of FIG. 5, the discharge current from the lithium battery 6 is approximately constant. As soon as the state of charge of the lithium battery 6 reaches a lower bound, only the lead-acid battery is discharged in a second discharge phase E.

In the example of FIG. 5, the time when the lower bound of SOC_Li is reached, is determined by the moment in which the voltage at the lithium battery drops to an end-of-charge voltage V_Li_EOC. The charge control system 14 disconnects the lead-acid battery 12 from the load by opening the load switch 12 when the system voltage V_sys reaches an end-of-discharge voltage V_Pb_EOD.

FIG. 6 shows a second discharging process, wherein, in a discharge phase D′, the load draws more current than the lithium battery is able to deliver. In this case, the system voltage V_sys at the terminals of the lead battery 12 drops below the maximum open circuit voltage V_PBmax_OC of the lead-acid battery, as shown in the topmost diagram of FIG. 6, and the lead-acid battery 12 is discharged together with the lithium battery 6. The discharge phases D′ and E are similar to those described with reference to FIG. 5.

FIG. 7 shows a flow diagram of the discharging and the charging process which indicates the operation principle of the charge control system 14.

In a step 50, a charge/discharge control is activated, for example by plugging in the lead-acid battery 12 and the lithium battery 6. This may involve additional steps, such as checking the health of the batteries and the correct connection of the batteries. In a decision step 51, it is decided whether enough power is available to charge the batteries. In a decision step 52, it is decided if the lead-acid battery 12 is fully charged, for example by measuring the system voltage V_sys. If the lead-acid battery 12 is determined as fully charged, the lithium battery 6 is charged and the lead-acid battery 12 is provided with a trickle charge in a step 53. If it is determined in step 52 that the lead-acid battery 12 is not yet fully charged, it is decided, in a decision step 54, if the lead-acid battery 12 has reached an end-of-charge voltage.

If the lead-acid battery 12 has not yet reached the end-of-charge voltage, it is charged in a step 58. If, on the other hand, it is determined that the lead-acid battery has reached the end-of-charge voltage, the lead battery 12 is charged at a constant voltage while the lithium battery 6 is charged simultaneously.

If, in the decision step 51, it is determined that the generation does not exceed the consumption and the consumption is greater zero, than it is determined, in a decision step 55, if the lithium battery 6 is empty, wherein “empty” corresponds to a low SOC. If it is determined that the lithium battery 6 is empty, the lead-acid battery 12 is discharged in a step 56 while the state of charge SOC_Pb of the lead-acid battery 12 exceeds a lower bound of 30-40%, for example. If, on the other hand, it is determined in step 55, that the lithium battery 6 is not empty, the lithium battery 6 is discharged in a step 57. If, during execution of step 56, a load draws more current than the lithium battery 6 can supply, a voltage at terminals of the lead-acid battery 12 drops below the end-of-charge voltage V_EOC_Pb and the lead-acid battery 12 will also be discharged.

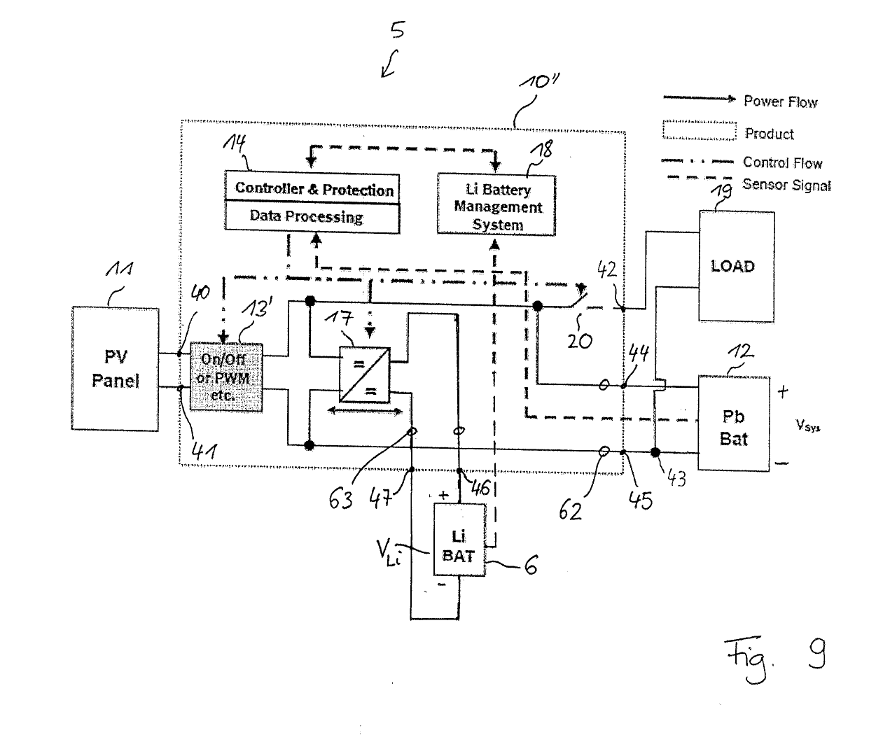

FIGS. 8 and 9 show further embodiments of a hybrid storage system 5, which are similar to the embodiment of FIGS. 1 to 3.

According to the embodiments of FIGS. 8 and 9, the batteries 6 and 12 do not form part of the hybrid storage system 5 but are plugged into the hybrid storage system 5.

According to one example, the batteries 6, 12 are provided with voltage sensors and connections for connecting the voltage sensors to the hybrid storage system 10. According to another example, the hybrid storage system is provided with a lead battery voltage sensor 62 and a lithium battery voltage sensor 63. Furthermore, an input voltage sensor 64 and a supply current sensor 65 may be provided. The sensors, which are symbolized by open circles, can be realized in various ways. For example, the sensors may be connected to two corresponding electric lines or two only one electric line. The current sensor may also be provided as magnetic field sensor.

The embodiment of FIG. 10 is similar to the embodiment of FIG. 9 but, in contrast to the preceding embodiment, the hybrid storage system 10 comprises only one DC/DC converter 17, which is provided for an adjustment of a voltage at terminals of the lithium battery 6. Instead of the second DC/DC converter 13, and input current adjustment means 13′ is provided, for example a controllable On/Off switch, a controllable pulse width modulation (PWM), an overvoltage protection or others. The current adjustment means may be connected to the charge control system 14 by a control line, as shown in FIG. 10.

In the abovementioned description, details have been provided to describe the embodiments of the application. It shall be apparent to one skilled in the art, however, that the embodiments may be practised without such details. For example, there are various circuit arrangements for realizing the components of the hybrid storage system. These circuit arrangements may have additional components or other components with similar functions as those shown in the detailed embodiment. For example, the transistors are shown as n-type unipolar transistors in the embodiments. The skilled person will recognize, however, that the arrangement can also be realized with p-type transistors. Other modifications may arise, for example, from reversing the polarity of the batteries, placing voltage sensors at different locations etc.

1-24. (canceled)

25. A hybrid battery charging device, comprising:
input terminals for connecting a photovoltaic panel;
first battery connections for connecting a lead-acid battery;
second battery connections for connecting a high-cycle chemical battery;
a two-way DC/DC converter having (i) a first set of terminals connected with the second battery connections and (ii) a second set of terminals connected with the first battery connections;
a charge-and-discharge control system connected to the DC/DC converter via respective control lines; and
output terminals for connecting a load, wherein an input to the output terminals is de-rived from the first battery connections.

26. The hybrid battery charging device of claim 25, further comprising:
a control device connected to the charge-and-discharge control system, wherein input terminals of the control device are connected to the input terminals for connecting the photovoltaic panel, and wherein output terminals of the control device are connected to input terminals of the two-way DC/DC converter.

27. The hybrid battery charging device of claim 26, wherein the control device is a pulse width modulator.

28. The hybrid battery charging device of claim 26, wherein the control device is a maximum power point tracker.

29. The hybrid battery charging device of claim 26, wherein the control device is a controllable switch.

30. The hybrid battery charging device of claim 26, wherein the control device is a second DC/DC converter.

31. The hybrid battery charging device of claim 26, wherein the two-way DC/DC converter is one of a buck-boost converter, a buck converter, or a boost converter.

32. The hybrid battery charging device of claim 26, wherein the two-way DC/DC converter comprises at least two semiconductor switches, and wherein respective input connections of the transistors are connected to the charge-and-discharge control system via respective control lines.

33. The hybrid battery charging device of claim 26, further comprising:
first voltage measuring connections for connecting a first voltage sensor, the first voltage sensor being connected to terminals of the lead-acid battery, and the first voltage measuring connections being connected to the charge-and-discharge control system; and
second voltage measuring connections for connecting a second voltage sensor, the second voltage sensor being connected to terminals of the high-cycle chemical battery, and the second voltage measuring connections being connected to the charge-and-discharge control system.

34. The hybrid battery charging device of claim 26, further comprising:
a separate battery management system for the high-cycle chemical battery, the separate battery management system being connected to the charge-and-discharge control system.

35. A hybrid storage system, comprising:
a high-cycle chemical battery; and
a hybrid battery charging device including:
input terminals for connecting a photovoltaic panel;
first battery connections for connecting a lead-acid battery;
second battery connections connected to the high-cycle chemical battery;
a two-way DC/DC converter having (i) a first set of terminals connected with the second battery connections and (ii) a second set of terminals connected with the first battery connections;
a charge-and-discharge control system connected to the DC/DC converter via respective control lines; and
output terminals for connecting a load, wherein an input to the output terminals is de-rived from the first battery connections.

36. The hybrid storage system according to claim 35, wherein the high-cycle chemical batter is a lithium battery.

37. The hybrid storage system according to claim 35, further comprising a capacitor which is connected in parallel to the high-cycle chemical battery.

38. The hybrid storage system according to claim 37, further comprising:
the lead-acid battery, wherein the lead-acid battery is connected to the first battery connections.

39. The hybrid storage system according to claim 38, further comprising:
a first voltage sensor which is connected to a terminal of the lead-acid battery and to the charge-and-discharge control system; and
a second voltage sensor which is connected to a terminal of the high-cycle chemical battery and to the charge-and-discharge control system.

40. A method for charging a lead-acid battery and a high-cycle chemical battery of a hybrid storage system by an electric power source, comprising:
charging the lead-acid battery in a first battery charging phase until the lead-acid battery has reached a first predetermined state of charge;
charging the lead-acid battery and the high-cycle chemical battery in a topping/boost/equalization phase until the lead-acid battery has reached a second predetermined state of charge; and
charging the high-cycle chemical battery in a third battery charging phase during which an essentially constant system voltage is applied to system terminals of the lead-acid battery and the system voltage is converted into a charging voltage at terminals of the high-cycle chemical battery.

41. The method according to claim 40, wherein during the topping/boost/equalization phase, an oscillating voltage is applied to the lead-acid battery, the oscillating voltage oscillating between a predetermined lower voltage and a predetermined upper voltage.

42. The method according to claim 41, further comprising:
maintaining a mean voltage at terminals of the lead-acid battery at an end-of-charge voltage of the lead-acid battery during the equalization phase.

43. The method according to claim 42, wherein, during the topping/boost/equalization phase, a system voltage at terminals of the lead acid battery is controlled to be constant such that a charge current to the lead-acid battery decreases and a remaining charging power is transferred to the high-cycle chemical battery.

44. (New The method according to claim 42, wherein the essentially constant system voltage applied to the system terminals during the charging of the high-cycle chemical battery in the third battery charging phase is equal to a maximum open circuit voltage of the lead-acid battery.

45. The method according to claim 44, wherein a decision for starting the topping/boost/equalization phase and a decision for starting the third battery charging phase are each taken depending on a system voltage at terminals of the lead-acid battery.

46. A method for discharging a lead-acid battery and a high-cycle chemical battery of a hybrid storage system, comprising:
supplying a load with power by discharging the high-cycle chemical battery via system terminals of the lead-acid battery and maintaining the voltage at the system terminals essentially equal to a maximum open circuit voltage of the lead-acid battery until the output voltage of the high-cycle chemical battery has reached an end-of-discharge voltage of the high-cycle chemical battery; and
discharging the lead-acid battery until the voltage of the lead-acid battery has reached an end-of-discharge voltage of the lead-acid battery.

47. The method according to claim 46, wherein the steps of discharging the high-cycle chemical battery and of discharging the lead-acid battery are executed in parallel.

48. A non-transitory, computer-readable data storage medium storing a computer program having program codes which, when executed on a computer, perform a method for charging a lead-acid battery and a high-cycle chemical battery of a hybrid storage system by an electric power source, the method comprising:
charging the lead-acid battery in a first battery charging phase until the lead-acid battery has reached a first predetermined state of charge;
charging the lead-acid battery and the high-cycle chemical battery in a topping/boost/equalization phase until the lead-acid battery has reached a second predetermined state of charge; and
charging the high-cycle chemical battery in a third battery charging phase during which an essentially constant system voltage is applied to system terminals of the lead-acid battery and the system voltage is converted into a charging voltage at terminals of the high-cycle chemical battery.
